(19) United States
(12) Patent Application Publication
(10) Pub. No.: US 2014/0082233 A1
(43) Pub. Date: Mar. 20, 2014

(54) PERFORMANCE-ENHANCING HIGH-SPEED INTERFACE CONTROL DEVICE AND DATA TRANSMISSION METHOD

(71) Applicant: SK hynix Inc., Icheon-si Gyeonggi-do (KR)

(72) Inventor: Hao Hsiang CHANG, Jhubei City (TW)

(73) Assignee: SK hynix Inc., Icheon-si Gyeonggi-do (KR)

(21) Appl. No.: 14/030,301

(22) Filed: Sep. 18, 2013

(30) Foreign Application Priority Data
Sep. 20, 2012 (TW) 101134436

(51) Int. Cl. G06F 5/06

(52) U.S. Cl. CPC G06F 5/065
USPC 710/52

(57) ABSTRACT

A method, which entails creating a connection in a high-speed interface between a first host and a second host and executing a first transmission mode and a second transmission mode synchronously, includes, in the first and second transmission modes: receiving and determining whether the first (second) host has sent a data transmission command; providing two transmitting channels when the determination is affirmative, with one said transmitting channel transmitting a vendor command to the second (first) host and the other transmitting channel transmitting data to the second (first) host.

### CROSS-REFERENCES TO RELATED APPLICATIONS

The present application claims priority to Taiwanese patent application number 101134436 filed on Sep. 20, 2012, in the Taiwan Intellectual Property Office, which is incorporated herein by reference in its entirety.

### BACKGROUND 1. Technical Field

The present disclosure generally relates to high-speed interface control devices and data transmission methods, and more particularly, to a technology of effectuating full-duplex data transmission with a high-speed communication interface to thereby enhance data transmission performance efficiently.

2. Related Art

Due to technological advancements, plenty of high-speed transmission interfaces were developed. The history of development of universal serial bus (USB) reflects user demand for communication interface transmission speed. USB 1.0, the first USB version released, is a low-speed interface with a transmission bandwidth of just 1.5 Mbps. USB 1.1, the second USB version released, has its maximum transmission bandwidth increased to 12 Mbps. Next came USB 2.0 with a maximum transmission bandwidth of 480 Mbps. The heyday of USB 2.0 saw the advent of a technology of enabling two hosts to send data to each other by USB 2.0 with a view to enhancing data transmission performance further. However, the subsequent emergence of high-speed transmission interfaces and high-capacity data transmission outshines the technology of performing bidirectional data transmission between two hosts by USB 2.0 in terms of user demand. USB 3.0, the latest USB version released, has its maximum transmission bandwidth increased greatly from 480 Mbps to 5 Gbps, and its pin numbers and signals are defined as follows:

1 VBUS

2 D−

3 D+

4 GND

5 StdASSRX−

6 StdA_SSRX+

7 GND_DRAIN

8 StdA_SSTX−

9 StdA_SSTX+

As indicated above, USB 3.0 not only keeps downward-compatible pins (VBUS, D−, D+, GND), but also further expands to include a group of high-speed receiving pins (StdASSRX−, StdA_SSRX+) and a group of high-speed transmitting pins (StdA_SSTX−, StdA_SSTX+). That is to say, USB 3.0 enables both a data transmitting function and a data receiving function. However, USB 3.0-based data transmission is restricted to half-duplex transmission. Although USB 3.0 is configured with both a receiving channel and a transmitting channel, the receiving channel and the transmitting channel cannot receive and transmit data simultaneously. It is not until the receiving channel has finished receiving data that the transmitting channel begins to transmit data; hence, in practice, USB 3.0-based data transmission is restricted to half-duplex transmission. The aforesaid phenomenon occurs to the other high-speed transmission interfaces, such as eSATA and PCI-Express.

As indicated above, although there have been improvements on conventional high-speed transmission interfaces in transmission bandwidth and speed, their receiving channel and transmitting channel remain unfit for full-duplex transmission. As a result, there is still room for improvement in data transmission efficiency of high-speed transmission interfaces.

### SUMMARY

In view of the aforesaid drawbacks of the prior art—high-speed transmission interfaces are not capable of full-duplex transmission to the detriment of their data transmission performance, it is an objective of the present invention to provide a performance-enhancing high-speed interface control device and data transmission method to allow existing high-speed transmission interfaces to perform full-duplex transmission and therefore enhance their data transmission efficiency.

In order to achieve the above and other objectives, an embodiment of the present invention provides a performance-enhancing high-speed interface control device, including: a first host interface port electrically coupled with a first host buffering unit; a second host interface port electrically coupled with a second host buffering unit; and a control unit electrically coupled with the first and second host buffering units, wherein the control unit controls the first and second host buffering units such that the first and second host interface ports receive and transmit data simultaneously via the first and second host buffering units.

In order to achieve the above and other objectives, an embodiment of the present invention provides a performance-enhancing high-speed interface data transmission method for creating a connection in a high-speed interface between a first host and a second host and executing a first transmission mode and a second transmission mode synchronously, wherein the first transmission mode includes: receiving and determining whether the first host has sent a data transmission command; and providing two transmitting channels when the determination is affirmative, with one said transmitting channel transmitting a vendor command to the second host and the other transmitting channel transmitting data to the second host; and the second transmission mode includes: receiving and determining whether the second host has sent a data transmission command; and providing two transmitting channels when the determination is affirmative, with one said transmitting channel transmitting a vendor command to the first host and the other transmitting channel transmitting data to the first host.

In order to achieve the above and other objectives, an embodiment of the present invention further provides a performance-enhancing high-speed interface control device which includes: a first host interface port comprising a first receiving port and a first transmitting port; a second host interface port comprising a second receiving port and a second transmitting port; a control unit built-in with a transmission protocol control procedure and comprising a first host connection port and a second host connection port; a first host buffering unit connected between the first host connection port of the control unit and the first host interface port and comprising a first instruction buffer, a first data output buffer, a first input data buffer, and a first control buffer, wherein the first instruction buffer and the first data output buffer are connected to the first transmitting port, wherein the first input data buffer and the first control buffer are connected to the first receiving port; and a second host buffering unit connected between the second host connection port of the control unit and the second host interface port and comprising a second instruction buffer, a second data output buffer, a second input data buffer, and a second control buffer, wherein the second instruction buffer and the second data output buffer are connected to the second transmitting port, wherein the second input data buffer and the second control buffer are connected to the second receiving port.

With regards to the performance-enhancing high-speed interface control device, the first and second host interface ports are connected to a first host and a second host, respectively, to enable the first host and the second host to transmit/receive data to/from each other simultaneously. A data transmission command sent from the first and second hosts are received by the first and second instruction buffers of the first and second host buffering units, respectively, and judged and confirmed by the control unit. If the control unit determines that the data transmission command is sent from the first host, not only will the first instruction buffer and the second control buffer provide a transmitting channel for transmitting a chip control instruction to the second host to instruct the second host to receive data, but the first data output buffer and the second input data buffer will also provide another transmitting channel for transmitting data sent from the first host to the second host via the second receiving port. If the control unit determines that the data transmission command is sent from the second host, not only will the second instruction buffer and the first control buffer provide a transmitting channel for transmitting via the first receiving port the chip control instruction to the first host to instruct the first host to receive data, but the second data output buffer and the first input data buffer will also provide another transmitting channel for transmitting data to the first host via the first receiving port of the first host interface port. Accordingly, the device and method of the present invention enable the first and second hosts to receive/transmit data from/to each other by full-duplex transmission, using a high-speed interface, and therefore enhance data transmission efficiency.

### BRIEF DESCRIPTION OF THE DRAWINGS

FIG. 1 is a circuit block diagram of a performance-enhancing high-speed interface control device according to an embodiment of the present invention;

FIG. 2 is a schematic view of the connection of the performance-enhancing high-speed interface control device and hosts according to the embodiments shown in FIG. 1 of the present invention;

FIG. 3 is a circuit block diagram of the performance-enhancing high-speed interface control device according to an embodiment of the present invention.

### DETAILED DESCRIPTION

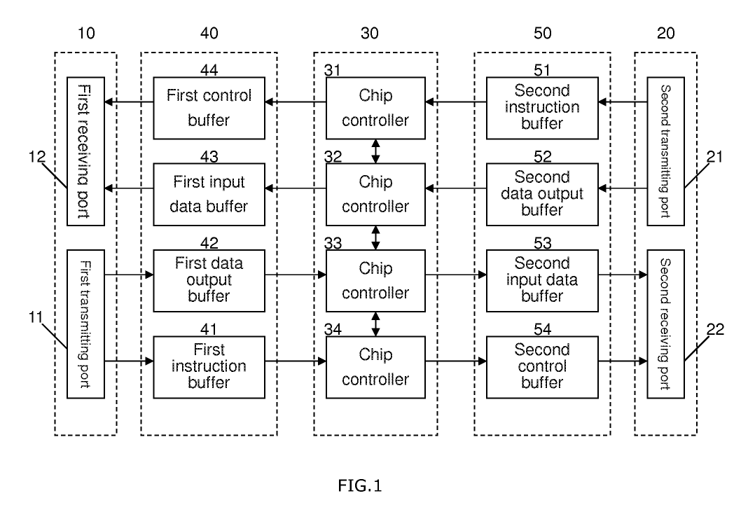

Referring to FIG. 1, in an embodiment of the present invention, a performance-enhancing high-speed interface control device may include a first host interface port 10, a second host interface port 20, a control unit 30, a first host buffering unit 40, and a second host buffering unit 50.

The first host interface port 10 may include a first receiving port 12 and a first transmitting port 11 which are connected to a first host (not shown) by a high-speed communication interface protocol (hereinafter referred to as a “high-speed interface”). The second host interface port 20 may include a second receiving port 22 and a second transmitting port 21 which are connected to a second host (not shown) by the high-speed interface. The high-speed interface is a high-speed serial bus with a transmitting end and a receiving end which are independent of each other, and it includes, but is not limited to, USB 3.0, eSATA, and PCI-Express. For illustrative purposes, the high-speed interface is exemplified by USB 3.0 below. The first and second receiving ports 12, 22 are the receiving ends StdA_SSRX−, StdA_SSRX+ of USB 3.0. The first and second transmitting ports 11, 21 are the transmitting ends StdA_SSTX−, StdA_SSTX+ of USB 3.0.

The control unit 30 is built-in with a transmission protocol control procedure and may include a first host connection port and a second host connection port. The first host connection port is connected to the first host interface port 10. The second host connection port is connected to the second host connection port 20. The control unit 30 is either a standalone microprocessor or may include a plurality of chip controllers connected to each other. In an embodiment, the control unit 30 may include a plurality of chip controllers 31˜34.

The first host buffering unit 40 may include a first instruction buffer 41, a first data output buffer 42, a first input data buffer 43, and a first control buffer 44. The first instruction buffer 41 and the first data output buffer 42 each have an input end connected to the first transmitting port 11 and each have an output end connected to the chip controllers 33, 34 of the control unit 30. The first input data buffer 43 and the first control buffer 44 each have an output end connected to the first receiving port 12 and each have an input end connected to the chip controllers 31, 32 of the control unit 30.

The second host buffering unit 50 may include a second instruction buffer 51, a second data output buffer 52, a second input data buffer 53, and a second control buffer 54. The second instruction buffer 51 and the second data output buffer 52 each have an input end connected to the second transmitting port 21 and each have an output end connected to the chip controllers 31, 32 of the control unit 30. The second input data buffer 53 and the second control buffer 54 each have an input end connected to the chip controllers 33, 34 of the control unit 30 and each have an output end connected to the second receiving port 22.

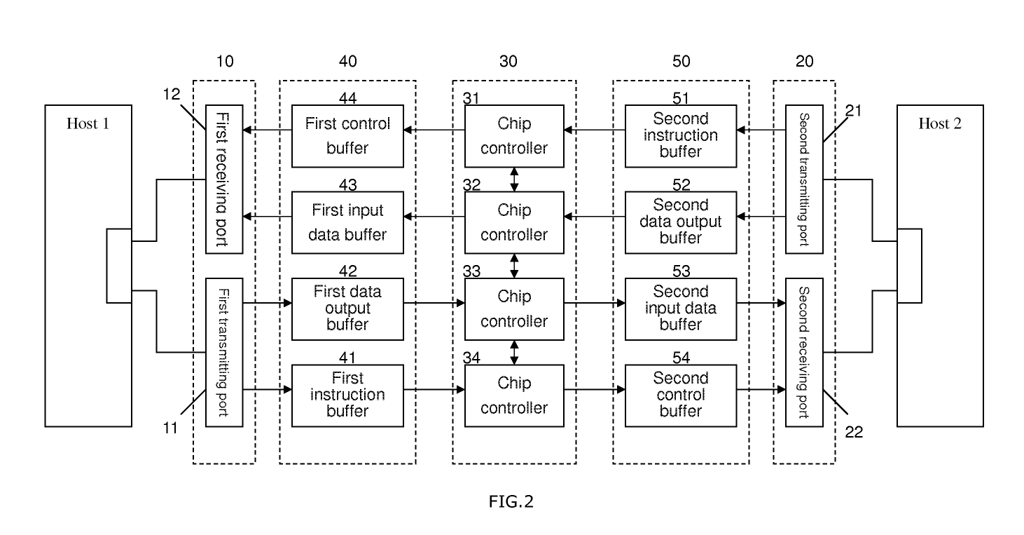

Referring to FIG. 2, after the first host interface port 10 and the second host interface port 20 have been connected to the USB 3.0 interface port of a first host (Host 1) and the USB 3.0 interface port of a second host (Host 2), respectively, the control unit 30, with the inbuilt transmission protocol control procedure, uses the first instruction buffer 41 to receive an instruction or command from the first host (Host 1), uses the second control buffer 54 to send a vendor command to the second host (Host 2) via the second receiving port 22, uses the first data output buffer 42 to receive from the first transmitting port 11 a data sent from the first host (Host 1), and uses the second input data buffer 53 to send the data to the second host (Host 2) via the second receiving port 22. Therefore, if the control unit 30 receives a data transmission command from the first host (Host 1), not only will the first instruction buffer 41 and the second control buffer 54 provide a transmitting channel for sending a chip control instruction to the second host (Host 2) to instruct the second host (Host 2) to receive the data, but the first data output buffer 42 and the second input data buffer 53 will also provide another transmitting channel whereby the data sent from the first host (Host 1) via the first transmitting port 11 is sent to the second host (Host 2) via the second receiving port 22.

The control unit 30 further determines whether the second host (Host 2) has sent the data transmission command. If the determination is affirmative, not only will the second instruction buffer 51 and the first control buffer 44 provide a transmitting channel for sending the chip control instruction to the first host (Host 1) via the first receiving port 12 to instruct the first host (Host 1) to receive the data, but the second data output buffer 52 and the first input data buffer 43 will also provide another transmitting channel for sending the data to the first host (Host 1) via the first receiving port 12 of the first host interface port 10.

Therefore, under the control of the control unit 30, the first host (Host 1) and the second host (Host 2) can receive/transmit data from/to each other simultaneously and thereby perform full-duplex transmission to enhance data transmission efficiency.

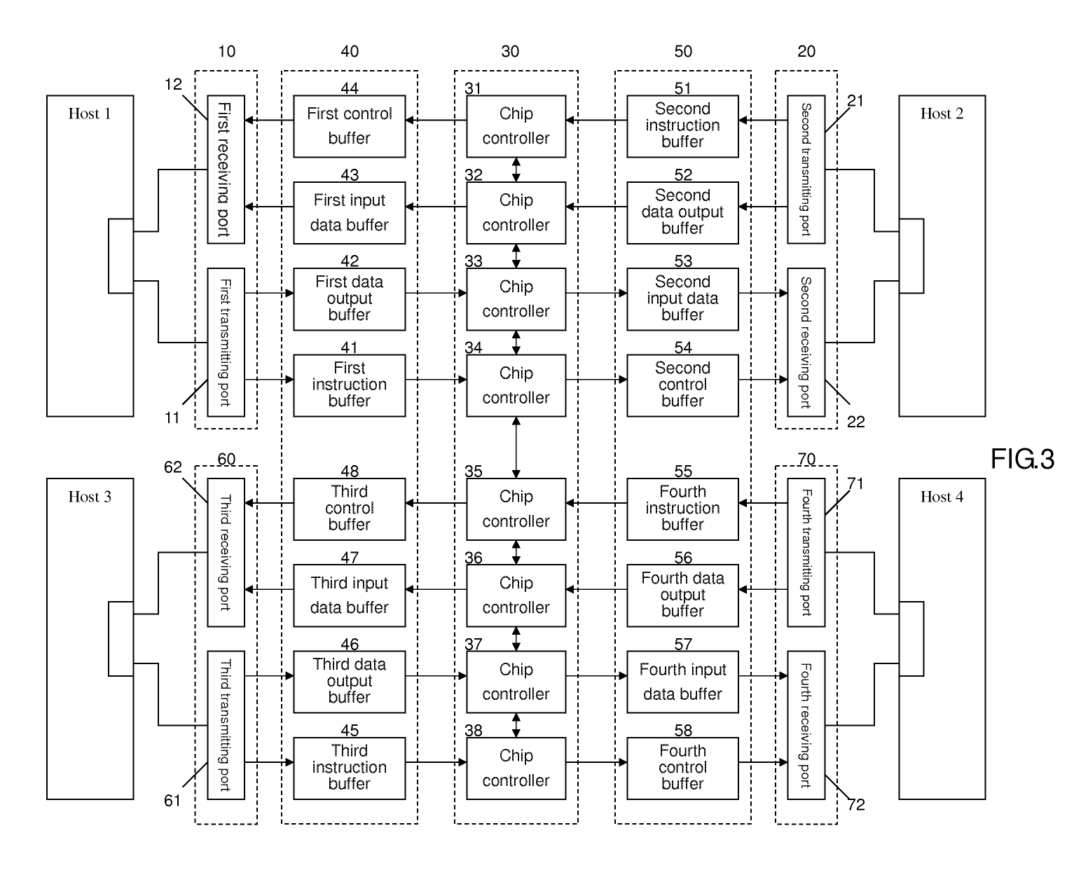

The technical features and principles of a preferred embodiment of the present invention are described above in detail. Persons skilled in the art understand that the high-speed interface control device disclosed in the aforesaid embodiment is a smallest unit connected between two hosts to enable the two hosts to receive/transmit data from/to each other simultaneously by full-duplex transmission. Given the aforesaid framework, the high-speed interface control device can be expanded as needed to increase the buffers of the first and second host buffering units 40, 50 and the host interface ports in a paired manner and expand the control unit 30 (by increasing the quantity of the chip controllers, for example), so as to increase the quantity of the hosts connected. Referring to FIG. 3, based on the aforesaid embodiments, the buffers of the first and second host buffering units 40, 50, the host interface ports, and the chip controllers of the control unit 30 are each expanded twofold.

The control unit 30 further includes four chip controllers 35-38 and further includes a third host interface port 60 and a fourth host interface port 70. The third host interface port 60 may include a third receiving port 62 and a third transmitting port 61 which are paired and connected to a third host (Host 3). The fourth host interface port 70 may include a fourth receiving port 72 and a fourth transmitting port 71 which are paired and connected to a fourth host (Host 4).

The first host buffering unit 40 expands to include, in addition to the first instruction buffer 41, the first data output buffer 42, the first input data buffer 43, and the first control buffer 44, a group of buffers, namely a third instruction buffer 45, a third data output buffer 46, a third input data buffer 47, and a third control buffer 48 which are connected to the chip controllers 35˜38 of the control unit 30 and the third host interface port 60, respectively.

The second host buffering unit 50 expands to include, in addition to the second instruction buffer 51, the second data output buffer 52, the second input data buffer 53, and the second control buffer 54, a group of buffers, namely a fourth instruction buffer 55, a fourth data output buffer 56, a fourth input data buffer 57, and a fourth control buffer 58 which are connected to the chip controllers 35˜38 of the control unit 30 and the fourth host interface port 70, respectively.

The aforesaid expansion not only enables the first host (Host 1) and the second host (Host 2) to receive/transmit data from/to each other by full-duplex transmission, but also enables bidirectional data transmission to occur between the third host (Host 3) and the fourth host (Host 4) by full-duplex transmission.

What is claimed is:

1. A performance-enhancing high-speed interface control device, comprising:
a first host interface port comprising a first receiving port and a first transmitting port;
a second host interface port comprising a second receiving port and a second transmitting port;
a control unit comprising a first host connection port and a second host connection port;
a first host buffering unit electrically coupled with the first host connection port of the control unit and the first host interface port and comprising a first instruction buffer, a first data output buffer, a first input data buffer, and a first control buffer, wherein the first instruction buffer and the first data output buffer are electrically coupled to the first transmitting port, wherein the first input data buffer and the first control buffer are electrically coupled to the first receiving port; and
a second host buffering unit electrically coupled with the second host connection port of the control unit and the second host interface port and comprising a second instruction buffer, a second data output buffer, a second input data buffer, and a second control buffer, wherein the second instruction buffer and the second data output buffer are electrically coupled to the second transmitting port, wherein the second input data buffer and the second control buffer are electrically coupled to the second receiving port,
wherein the control unit controls the first and second host buffering units such that the first and second host interface ports receive and transmit data simultaneously via the first and second host buffering units.

2. The performance-enhancing high-speed interface control device of claim 1, wherein the first and second host interface ports each comprise a high-speed serial bus.

3. The performance-enhancing high-speed interface control device of claim 2, wherein the first and second host interface ports each comprise a peripheral component interconnect express (PCI-Express).

4. The performance-enhancing high-speed interface control device of claim 2, wherein the first and second host interface ports each comprise an external serial advanced technology attachment (eSATA).

5. The performance-enhancing high-speed interface control device of claim 2, wherein the first and second host interface ports each comprise a universal serial bus (USB) 3.0.

6. The performance-enhancing high-speed interface control device of claim 1, wherein the control unit comprises a microprocessor.

7. The performance-enhancing high-speed interface control device of claim 1, wherein the control unit comprises a plurality of chip controllers electrically coupled to each other and electrically coupled to the first instruction buffer, the first data output buffer, the first input data buffer, and the first control buffer of the first host buffering unit, and the second instruction buffer, the second data output buffer, the second input data buffer, and the second control buffer of the second host buffering unit, respectively.

8. A performance-enhancing high-speed interface data transmission method for creating a connection in a high-speed interface between a first host and a second host and executing a first transmission mode and a second transmission mode synchronously, the first transmission mode comprising the steps of:
receiving and determining whether the first host has sent a data transmission command; and
providing two transmitting channels when the determination is affirmative, with one said transmitting channel transmitting a vendor command to the second host and the other transmitting channel transmitting data to the second host; and
the second transmission mode comprising the steps of:
receiving and determining whether the second host has sent a data transmission command; and
providing two transmitting channels when the determination is affirmative, with one said transmitting channel transmitting a vendor command to the first host and the other transmitting channel transmitting data to the first host.

9. A performance-enhancing high-speed interface control device, comprising:
a first host interface port electrically coupled with a first host buffering unit;
a second host interface port electrically coupled with a second host buffering unit; and
a control unit electrically coupled with the first and second host buffering units,
wherein the control unit controls the first and second host buffering units such that the first and second host interface ports receive and transmit data simultaneously via the first and second host buffering units.

10. The performance-enhancing high-speed interface control device of claim 9, wherein the first and second host interface ports each comprise a high-speed serial bus.

11. The performance-enhancing high-speed interface control device of claim 10, wherein the first and second host interface ports each comprise a peripheral component interconnect express (PCI-Express).

12. The performance-enhancing high-speed interface control device of claim 10, wherein the first and second host interface ports each comprise an external serial advanced technology attachment (eSATA).

13. The performance-enhancing high-speed interface control device of claim 10, wherein the first and second host interface ports each comprise a universal serial bus (USB) 3.0.

14. The performance-enhancing high-speed interface control device of claim 9, wherein the control unit comprises a microprocessor.

15. The performance-enhancing high-speed interface control device of claim 9, wherein the control unit comprises a plurality of chip controllers electrically coupled to each other and electrically coupled to the first and second host buffering units.
